(19) United States
(12) Patent Application Publication
(10) Pub. No.: US 2020/0013299 A1
(43) Pub. Date: Jan. 9, 2020

(54) SYSTEMS AND METHODS FOR DETECTING AIR TURBULENCE WITHIN AN AIR SPACE

(71) Applicant: THE BOEING COMPANY, Chicago, IL (US)

(72) Inventors: Aaron John Jacobson, Castle Rock, CO (US); Scott Allen Lueck, Denver, CO (US); Kenneth Gochenour, Commerce City, CO (US)

(73) Assignee: THE BOEING COMPANY, Chicago, IL (US)

(21) Appl. No.: 16/030,176

(22) Filed: Jul. 9, 2018

(51) Int. Cl. G08G 5/00; G01W 1/00

(52) U.S. Cl. CPC G08G 5/0091; G08G 5/003; G01W 2001/003; G01W 1/00; G08G 5/0047

(57) ABSTRACT

An air turbulence analysis system and method include an air turbulence control unit that is configured to receive motion signals from one or more motion sensors of a plurality of aircraft within an air space. The air turbulence control unit determines locations of air turbulence within the air space based on the motion signals.

### FIELD OF THE DISCLOSURE

Embodiments of the present disclosure generally relate to systems and methods of detecting air turbulence within an air space.

### BACKGROUND OF THE DISCLOSURE

Aircraft are used to transport passengers and cargo between various locations. Each aircraft typically flies between different locations according to a defined flight plan. During a flight, an aircraft may experience air turbulence, which may cause a variation in the flight plan. For example, during periods of air turbulence, a pilot may ascend, descend, or re-route an aircraft to leave or otherwise avoid the air turbulence.

General locations of likely air turbulence may be predicted through weather reports. Based on meteorological forecasts, predictions are made as to where air turbulence may arise. However, the meteorological forecasts may not be completely accurate, and may not accurately locate air turbulence within an air space.

Further, pilots flying aircraft may report to air traffic control locations of air turbulence. For example, a pilot flying through air turbulence may contact air traffic control to report the air turbulence. As can be appreciated, however, pilots perceptions of motion caused by air turbulence may vary. Also, pilots may be reluctant to report locations of air turbulence, such as if they believe reporting the air turbulence may cause air traffic control to alter flight plans of other aircraft (which may, for example, increase flight times for other flights). Further, air turbulence may cause different motion in different types of aircraft. As an example, a large aircraft may not be as affected by air turbulence as compared to a smaller aircraft.

In short, determinations of air turbulence may be imprecise and subjective. Accordingly, flights may inadvertently pass through air turbulence, or re-route in in relation to a flight plan when at least portions of the original flight plan would generally not be affected by air turbulence.

### SUMMARY OF THE DISCLOSURE

A need exists for a system and method that accurately and timely determine locations of air turbulence within an air space. Further, a need exists for an objective system and method of determining air turbulence within an air space that does not rely on weather forecasts or subjective opinions regarding air turbulence.

With those needs in mind, certain embodiments of the present disclosure provide an air turbulence analysis system that includes an air turbulence control unit that is configured to receive motion signals from one or more motion sensors of a plurality of aircraft within an air space. The air turbulence control unit determines locations of air turbulence within the air space based on the motion signals.

In at least one embodiment, a turbulence modeling control unit is configured to generate a turbulence map based on the locations of air turbulence as determined by the air turbulence control unit. The turbulence modeling control unit may transmit the turbulence map to one or more of the plurality of aircraft. In at least one embodiment, the turbulence modeling control unit stores air turbulence map data over time. The stored air turbulence may data may be used to form a dynamic turbulence map that allows for visualization of locations of the turbulence in the air space over time.

In at least one embodiment, the air turbulence control unit is configured to receive position signals from each of the plurality of aircraft. The position signals indicate the current positions of the plurality of the aircraft within the air space. The air turbulence control unit correlates the position signals with the motion signals to determine the locations of the air turbulence within the air space. In at least one embodiment, the motion signals are transmitted by the aircraft through the position signals.

The motion sensors may include a plurality of motions sensors. For example, each of the plurality of aircraft includes a plurality of motion sensors. The motion sensors may include one or more of an accelerometer, a gyroscope, an inertial sensor, a global positioning system (GPS) unit, or the like.

In at least one embodiment, the air turbulence control unit analyzes normalization data that relates to the plurality of aircraft. The normalization data allows for an objective determination of air turbulence, and a severity of air turbulence to be categorized for different types of aircraft.

The air turbulence control unit may be within a land-based monitoring center.

At least one motion data collection unit may collect the motion signals. In at least one embodiment, the plurality of aircraft includes motion data collection units.

The air turbulence system may include a flight plan database that stores flight plan data for the plurality of aircraft within the air space. The air turbulence control unit compares the motion signals with the flight plan data for the plurality of aircraft to determine the locations of air turbulence within the air space.

The air turbulence system may determine a severity of the locations of air turbulence within the air space by analyzing the motion signals in relation to one or more predetermined thresholds.

Certain embodiments of the present disclosure provide an air turbulence analysis method that includes receiving, by an air turbulence control unit, motion signals from one or more motion sensors of a plurality of aircraft within an air space, and determining, by the air turbulence control unit, locations of air turbulence within the air space based on the motion signals.

In at least one embodiment, the method also includes generating, by a turbulence modeling control unit, a turbulence map based on the locations of air turbulence as determined by the air turbulence control unit. The method may also include transmitting the turbulence map to one or more of the plurality of aircraft. In at least one embodiment, the method includes storing air turbulence map data, and forming a dynamic turbulence map from the air turbulence map data that is stored.

In at least one embodiment, the method includes receiving, by the air turbulence control unit, position signals from each of the plurality of aircraft (wherein the position signals indicate the current positions of the plurality of the aircraft within the air space), and correlating, by the air turbulence control unit, the position signals with the motion signals to determine the locations of the air turbulence within the air space.

In at least one embodiment, the method includes analyzing normalization data that relates to the plurality of aircraft to allow for an objective determination of air turbulence, and a severity of air turbulence to be categorized for different types of aircraft.

The method may also include positioning the air turbulence control unit within a land-based monitoring center.

The method may also include collecting the motion signals with at least one motion data collection unit.

In at least one embodiment, the method includes storing flight plan data for the plurality of aircraft within the air space within a flight plan database. The determining includes comparing the motion signals with the flight plan data for the plurality of aircraft to determine the locations of air turbulence within the air space.

In at least one embodiment, the determining further includes determining a severity of the locations of air turbulence within the air space by analyzing the motion signals in relation to one or more predetermined thresholds.

### BRIEF DESCRIPTION OF THE DRAWINGS

FIG. 1 illustrates a schematic block diagram of an air turbulence analysis system, according to an embodiment of the present disclosure.

FIG. 2 illustrates a simplified view of a plurality of aircraft within an air space above a turbulence map, according to an embodiment of the present disclosure.

FIG. 3 illustrates a front perspective view of an aircraft, according to an exemplary embodiment of the present disclosure.

FIG. 4 illustrates a flow chart of an air turbulence analysis method, according to an embodiment of the present disclosure.

FIGS. 5A-5E illustrate flow charts of an air turbulence analysis method, according to an embodiment of the present disclosure.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular condition may include additional elements not having that condition.

Certain embodiments of the present disclosure provide air turbulence analysis systems and methods that use objective data to determine locations of air turbulence within an air space. In at least one embodiment, a plurality of motion sensors aboard one or more aircraft detect motion of the aircraft. The plurality of motion sensors output motion data that may be aggregated and normalized. The motion data is analyzed by an air turbulence control unit to objectively determine areas of flight turbulence within an air space. The air turbulence control unit may receive data from numerous aircraft within the air space to determine the existence of air turbulence within the air space.

In at least one embodiment, the air turbulence systems and methods receive real time, objective motion data from motions sensors of various aircraft. The motion data is communicated to the air turbulence control unit, such as through one or more communication signals. In at least one embodiment, the motion data may be communicated to the air turbulence control unit via position signals, such as ADS-B signals, which are also used to determine current locations of the aircraft.

In at least one embodiment, the air turbulence systems and methods also generate a real time or near real time air turbulence map or model, which shows or otherwise indicates the locations of the air turbulence within an air space. The air turbulence map or model provides air turbulence information at particular locations and altitudes. Pilots may review the air turbulence map or model to make informed decisions to avoid areas of air turbulence, whether at a particular position or altitude. For example, a pilot may see that air turbulence is present at a particular altitude within a geospatial location. As such, the pilot may avoid the air turbulence by descending or ascending to a particular altitude below or above the air turbulence, or fly around the air turbulence.

The air turbulence systems and methods determine locations of air turbulence within an air space based on objective motion data received from aircraft, instead of weather models, predictions, or pilot observations. The motion data may be constantly received and analyzed by a monitoring center to provide real time or near real time determinations of locations of air turbulence (including start and end areas) within an air space, instead of point only detection (as is the case with pilot reports, for example).

In at least one embodiment, the air turbulence systems and methods generate an air turbulence map by collecting and analyzing motion data from multiple flights within a particular air space. The motion data may be transmitted to a monitoring center via ADS-B signals. An air turbulence control unit analyzes the received motion data from the multiple flights to determine locations and severity of air turbulence within the air space. A turbulence modeling control unit aggregates the motion data from the flights to generate the air turbulence map.

Certain embodiments of the present disclosure provide an air turbulence analysis system that includes an air turbulence control unit that is configured to receive motion signals from one or more motion sensors of a plurality of aircraft within an air space. The air turbulence control unit determines locations of air turbulence within the air space based on the motion signals. In at least one embodiment, a turbulence modeling control unit is configured to generate a turbulence map based on the locations of air turbulence as determined by the air turbulence control unit.

In at least one embodiment, the air turbulence control unit is configured to receive position signals from each of the plurality of aircraft. The position signals indicate the current positions of the plurality of the aircraft within the air space. The air turbulence control unit correlates the position signals with the motion signals to determine the locations of the air turbulence within the air space. For example, for a position signal received from a particular aircraft, the air turbulence control unit correlates the motion signal(s) received from that particular aircraft to determine a precise location of air turbulence within the air space.

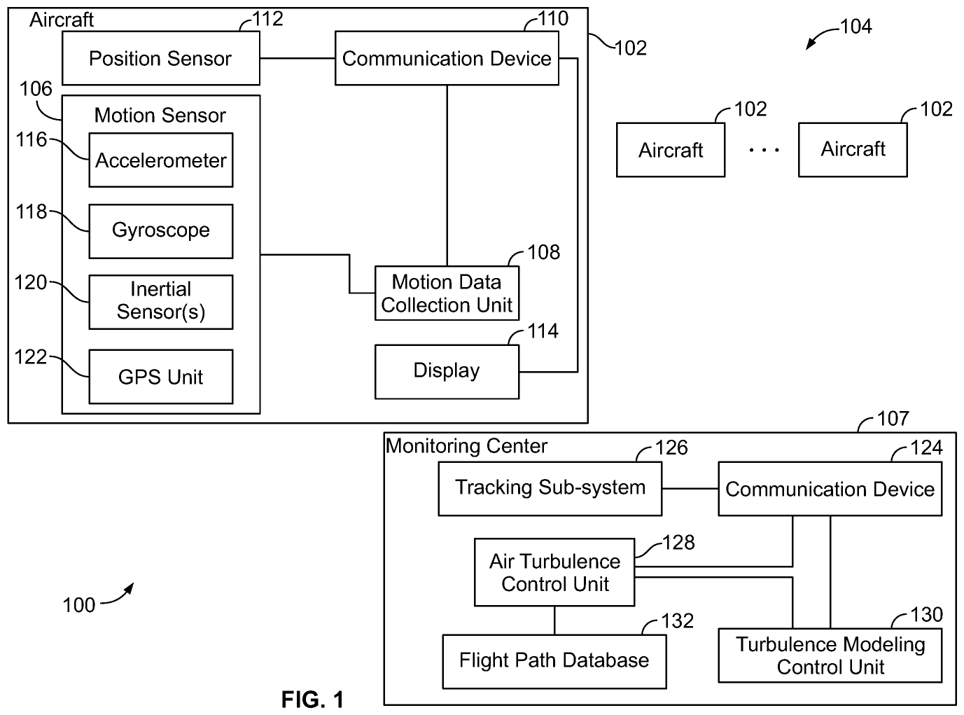

FIG. 1 illustrates a schematic block diagram of an air turbulence analysis system 100, according to an embodiment of the present disclosure. The air turbulence analysis system 100 includes one or more aircraft 102 within an air space 104 in communication with a monitoring center 107. The air space 104 may be over a defined region, such as within a 500 mile radius from the monitoring center 107. Optionally, the air space 104 may be over a smaller or larger area than within a 500 mile radius from the monitoring center 107. As an example, the air space 104 may be over an entire hemisphere or even over an entire surface of the Earth.

In at least one embodiment, the monitoring center 107 is in communication with all aircraft 102 within the air space 104 to determine locations of air turbulence within the air space 104. By increasing the number of aircraft 102 within the air space 104 that are monitored by the monitoring center 107 to determine locations of air turbulence, the accuracy of the determined locations of air turbulence is increased. As such, the monitoring center 107 being in communication with all of the aircraft 102 within the air space 104 provides the most accurate assessment of locations of air turbulence within the air space 104. Alternatively, the monitoring center 107 may be in communication with less than all aircraft 102 within the air space 104 to determine locations of air turbulence within the air space 104. In at least one embodiment, the monitoring center 107 may be in communication with only one aircraft 102 within the air space 104 to determine locations of air turbulence within the air space 104.

Each aircraft 102 includes one or more motion sensors 106 in communication with a motion collection unit 108, such as through one or more wired or wireless connections. The motion data collection unit 108 is in communication with a communication device 110, such as through one or more wired or wireless connections. Optionally, the aircraft 102 may not include the motion data collection unit 108. Instead, each of the motion sensors 106 may be in communication with the communication device 110, such as through one or more wired or wireless signals.

The motion sensors 106 are configured to detect motion (for example, inertial motion) of the aircraft 102 and output the detected motion via motion signals that are received by the motion data collection unit 108 and/or the communication device 110. The communication device 110 outputs the motion signals to the monitoring center 107 via the communication device 110.

A position sensor 112 is also in communication with the communication device 110, such as through one or more wired or wireless connections. The position sensor 112 may be separate and distinct from the communication device 110. In at least one other embodiment, the communication device 110 may be part of the position sensor 112, such as a transmitter and/or receiver of the position sensor 112. The position sensor 112 is configured to detect a current position of the aircraft 102 within the air space 104 and output a position signal to the monitoring center 107 via the communication device 110.

A display 114 is also in communication with the communication device 110, such as through one or more wired or wireless connections. The display 114 may be a monitor, such as within a cockpit of the aircraft (102), which shows information thereon. For example, the display 114 may show information received from the monitoring center 107 via the communication device 110.

In at least one embodiment, the motion sensors 106 include a plurality of motion sensors 106 on and/or within the aircraft 106. For example, the motion sensors 106 may be within instrumentation within a cockpit of the aircraft. As another example, the motion sensors 106 may be on or within structural components of the aircraft, such as wings, a fuselage, an empennage, and/or the like. The motion sensors 106 may include an accelerometer 116, a gyroscope 118, one or more inertial sensors 120, and a global positioning system (GPS) unit 122. The motion sensors 106 may include various other sensors that may directly or indirectly detect motion of the aircraft 102, such as magnetometers, barometers, and/or the like.

The accelerometer 116 and gyroscope 118 may be within a cockpit, fuselage, or the like of the aircraft 102. In at least one embodiment, the aircraft 102 may include multiple accelerometers 116 and gyroscopes 118. For example, one or more accelerometers 116 and one or more gyroscopes 118 may be within a cockpit, passenger cabin, on or within structural components, and/or the like.

The inertial sensors 120 may similarly be located on, within, or throughout the aircraft 102. For example, the inertial sensors 120 may be pedometers within mobile devices (for example, smart phones) of flight staff and/or passengers that are in communication with the motion data collection unit 108 and/or the communication device 110, such as through wireless connections (for example, WiFi).

One or more GPS units 122 may be within the aircraft 102. For example, instrumentation within the cockpit may include a GPS unit 122. As another example, GPS units may be within mobile devices of flight staff and/or passengers that are in communication with the motion data collection unit 108 and/or the communication device 110, such as through wireless connections.

The communication device 110 may be one or more antennas, radio units, transceivers, receivers, transmitters, and/or the like. The communication device 110 is configured to receive and transmit data with the monitoring center 107 via a reciprocal or otherwise similar communication device 124 of the monitoring center 107. In at least one embodiment, the aircraft 102 communicates with the monitoring center 107, via the respective communication devices 110 and 124, such as through a positional communication protocol.

The position sensor 112 may be a global positioning system sensor, an automatic dependent surveillance-broadcast (ADS-B) sensor, and/or the like. In at least one embodiment, the position sensor 112 is an ADS-B sensor that communicates a current position to the monitoring center 107 via ADS-B signals, which may be output by the communication device 110. As noted, the communication device 110 may be part of the position sensor 112. In this manner, the motion signals output by the motion sensors 106 may be output to the monitoring center 107 through the positional communication information protocol, such as via ADS-B signals.

The monitoring center 107 may be an air traffic control center, such as at an airport. The monitoring center 107 may be land-based. In at least one other embodiment, the monitoring center 107 may be onboard an aircraft 102. In at least one other embodiment, the monitoring center 107 may be outside of the atmosphere of the Earth, such as within a space station, satellite, or the like.

The monitoring center 107 includes a tracking sub-system 126 in communication with the communication device 124 through one or more wired or wireless connections. The tracking sub-system 126 receives position signals output by the position sensors 112 of the aircraft to determine current positions of the aircraft 102 within the air space 104. In at least one embodiment, the tracking sub-system is an ADS-B tracking sub-system that receives ADS-B signals from the position sensor 112.

The monitoring center 107 also includes an air turbulence control unit 128 in communication with the communication device 124 through one or more wired or wireless connections. The air turbulence control unit 128 receives the motion signals 106 output by the motion sensors 106 of the aircraft 102 to determine whether the aircraft 102 are experiencing air turbulence at their current positions. The motion signals output by the motion sensors 106 may be output from the aircraft 102 to the air turbulence control unit 128 through position signals, such as ADS-B signals, which also are used to determine the current positions of the aircraft 102.

In at least one embodiment, the aircraft 102 may not include the motion data collection unit 108. Instead, the air turbulence control unit 128 receives the various motion signals from the motion sensors 106 as they are output. In at least one other embodiment, the motion data collection unit 108 collects the output motion signals from the motion sensors 106 and outputs the collected motion signals to the air turbulence control unit 128. In at least one other embodiment, the monitoring center 107 may include the motion data collection unit 108. For example, the motion data collection unit 108 may be in communication with, or part of, the air turbulence control unit 128.

The air turbulence control unit 128 is also in communication with a turbulence modeling control unit 130 through one or more wired or wireless connections. The air turbulence control unit 128 and the turbulence modeling control unit 130 may be separate and distinct control units. Optionally, the air turbulence control unit 128 and the turbulence modeling control unit 130 may be part of a single control unit.

The turbulence modeling control unit 130 receives air turbulence data from the air turbulence control unit 128. The air turbulence data is based on motion data as received by the motion signals output from the aircraft. The air turbulence data is analyzed by the turbulence modeling control unit 130, which generates an air turbulence map of the air space 104.

The monitoring center 107 may also include a flight plan database 132, which may be in communication with the air turbulence control unit 128 through one or more wired or wireless connections. The flight plan database 132 stores flight plan data for the aircraft 102 within the air space 104. In at least one embodiment, the air turbulence control unit 128 compares the received motion signals received from the aircraft with the flight plans stored in the flight plan database 132 to determine locations of air turbulence within the air space based on deviations from the flight plans. For example, the motion signals received from the aircraft 102 may indicate altitude and/or heading differences with the stored flight plans. As such, the air turbulence control unit 128 may then determine that the aircraft 102 are flying through air turbulence.

In at least one other embodiment, the air turbulence control unit 128 may not be in communication with the flight plan database 132. Instead, the air turbulence control unit 128 is configured to determine air turbulence through analysis of the motion signals received from the aircraft 102.

In operation, each aircraft 102 flies within the air space 104 according to a flight plan. Details of the flight plans may be stored in the flight plan database 132. The tracking sub-system 126 of the monitoring center 107 tracks current positions of each of the aircraft 102 within the air space 104 through the position signals output by the position sensors 112 of the aircraft 102. For example, the position signals may be ADS-B signals output by the position sensors 112 that are monitored by the tracking sub-system 126, which may be an ADS-B tracking sub-system 126.

The motion sensors 106 onboard the aircraft 102 also detect motion (for example, inertial motion) of the aircraft 102. The motion sensors 106 detect the motion and output the motion signals, which may or may not be collected by the motion collection unit 108, to the air turbulence control unit 128. In at least one embodiment, the motion signals are output to the air turbulence control unit 128 via the position signals (such as ADS-B signals), which also indicate a current position and altitude of the aircraft 102 within the air space 104.

For each monitored aircraft 102, the air turbulence control unit 128 detects the existence of air turbulence at each current position of the aircraft 102 within the air space by analyzing the motion signals output by the motion sensors 106 of the aircraft 102. For example, for each aircraft 102, the air turbulence control unit 128 may average all of the motion signals output by the motion sensors 106 to provide motion data for each aircraft 102 at its current position (as detected by the position sensor 112). In at least one embodiment, the air turbulence control unit 128 may determine motion data by removing, deleting, or otherwise ignoring motion signals from each aircraft 102 that are below a particular determined threshold (such as, for example, a lower 5-10%) and/or above a particular determined threshold (such as, for example, an upper 5-10%).

The air turbulence control unit 128 may compare the motion data with respect to a predetermined motion threshold to determine the existence of air turbulence at each current position of the aircraft 102. For example, if the motion data indicates an ascent, descent, or heading change that exceeds a particular amount over a particular amount of time, the air turbulence control unit 128 may determine the existence of air turbulence at the current position of the aircraft 102.

In at least one embodiment, the air turbulence control unit 128 compares the motion data in relation to the flight plan stored in the flight plan database 132 to determine the existence of air turbulence. For example, if the motion data output by the motion sensors 106 of the aircraft 102 at a current position, altitude, and/or heading (as determined by the position sensor 112) deviates from a predetermined amount of the stored flight plan, the air turbulence control unit 128 determines the existence of air turbulence at the current position and altitude of the aircraft 102.

In at least one embodiment, the flight plan database 132 may store normalization data regarding each aircraft 102 within the air space 104. The normalization data may include information about the size, weight, and the like of each aircraft 102. The normalization data may be used to send information to various aircraft 102 that takes the aircraft type, size, weight, and/or the like into consideration. The effects of air turbulence may be less in relation to larger aircraft 102 than smaller aircraft 102, for example. As such, motion data received from all aircraft 102 may be weighted and/or otherwise normalized so as to correlate motion of all aircraft 102 with a determination of air turbulence, regardless of type, size, weight, shape, and/or the like of the aircraft 102. For example, a large aircraft 102 may experience air turbulence as moderate air turbulence, while a smaller aircraft 102 may experience the air turbulence as severe turbulence. The normalization of motion signals received from the various aircraft 102 allows for an objective determination of air turbulence, and allows the severity of air turbulence to be categorized for different types of aircraft 102. In at least one embodiment, the normalization data may be stored in another component, such as a separate memory coupled to the air turbulence control unit 128, and/or a memory of the air turbulence control unit 128.

The air turbulence control unit 128 may also determine a severity of detected air turbulence for the aircraft 102 at current positions and altitudes based on predetermined thresholds. For example, if the motion data is less than a low threshold (such as detected motion that less than a +/−0.01% deviation from a predetermined baseline altitude, heading, air speed, or the like), then the air turbulence control unit 128 determines that the aircraft 102 is not experiencing air turbulence at its current position and altitude. If, however, the motion data is above the low threshold and less than a moderate threshold (such as between a +/−0.01% and +/−0.05% deviation from a predetermined baseline altitude, heading, air speed, or the like), then the air turbulence control unit 128 determines that the aircraft 102 is experiencing a moderate amount of air turbulence at its current position and altitude. If the motion data exceeds a high threshold (such as +/−0.05% deviation from a predetermined baseline altitude, heading, air speed, or the like), then the air turbulence control unit 128 determines that the aircraft 102 is experiencing a high amount of air turbulence at its current position and altitude.

In at least one embodiment, the air turbulence control unit 128 analyzes the motion signals received from all of the aircraft 102 within the air space 104 to determine locations of air turbulence therein. The air turbulence control unit 128 utilizes the current positions of the aircraft 102 within the air space 104 and the motion signals output by the aircraft 102 to determine real time or near real time locations of air turbulence within the air space 104. The turbulence modeling control unit 130 then generates a turbulence map based on the locations of the air turbulence within the air space 104. The turbulence modeling control unit 130 may indicate air turbulence of varying severity through surface contours, colors, text, and/or the like. The turbulence modeling control unit 130 continually updates the turbulence map based on the continual monitoring of the aircraft 102 by the air turbulence control unit 128. The turbulence modeling control unit 130 outputs map data indicative of the generated turbulence map to the aircraft 102 through communication signals output by the communication device 124. For example, the communication signals may be ADS-B signals.

The aircraft 102 receives the map data via the communication device 110. The display 114 may receive the map data and show the real time or near real time generated turbulence map thereon. As such, pilots may view the turbulence map on the display. The turbulence map is based on objective data (such as the motion signals output by the various aircraft 102 within the air space 104) to provide a real time visualization of areas of air turbulence within the air space 104. The pilots may compare the determined positions and altitudes of air turbulence on the display 114 with the current position of an aircraft 102 to avoid the areas of air turbulence.

In at least one embodiment, the air turbulence analysis system 100 may not show an air turbulence map on the displays 114 of the aircraft 102. Instead, the air turbulence control unit 128 determines locations of the air turbulence within the air space 104 and outputs air turbulence alert signals to the aircraft 102. For example, the air turbulence control unit 128 may output air turbulence alert signals that may be shown as text on the display 114 (for example, “currently approaching a 10 mile wide and 5 mile high pocket of air turbulence that is 50 miles away,” or the like).

As described herein, the air turbulence analysis system 100 includes the air turbulence control unit 128 that determines locations of air turbulence within the space 104 based on motion signals output by the motion sensors 106 of the aircraft 102. The turbulence modeling control unit 130 generates a turbulence map based on the locations of the air turbulence as determined by the air turbulence control unit 128. The turbulence map may be received by the aircraft 102 and shown on the displays 114 so that the pilots can readily see the locations (including positons and altitudes) of the locations of air turbulence within the air space 104.

The air turbulence control unit 128 may be configured to determine the locations of air turbulence within the air space 104 in real time based on the motion signals as output by the motion sensors 106 of the aircraft 102 within the air space, such as via onboard telemetry, internal accelerometers, gyroscopes, magnetometers, and barometers, and/or the like. The motion signals may be routed through an application from all airborne aircraft 102 over ADS-B where it may be merged by application logic into a real or near real time surface model for turbulence.

In at least one embodiment, redundant measurements may be run through a least squares adjustment model to calibrate motion sensor variables and remove error over time to provide a precision or confidence index. The turbulence model may be used to warn pilots about rough air space and provide them the option to reroute just in time. The monitoring center 107 (such as air traffic control) (ATC) may also have access to the near real-time turbulence surface model for pilots to reroute flights prior to departure.

The air turbulence control unit 128 and the turbulence modeling control unit 130 may continually monitor the aircraft 102 within the air space 104 to indicate (in real or near real time) where air turbulence starts and stops without the pilot needing to report. In at least one embodiment, the air turbulence control unit 128 may apply spatial logic that compares the flight plan for each aircraft 102 with the turbulence model to support passive notifications.

In at least one embodiment, the flight plan (for example, flight path) database 132 may store current flight plans for the aircraft 102, as well as optional or alternative candidate flight plans for the aircraft 102. The air turbulence control unit 128 may compare the current flight plans with the candidate flight plans in relation to the turbulence map generated by the turbulence modeling control unit 130 and output various alternative routes that avoid locations of turbulence. In this manner, the air turbulence control unit 128 may provide flight plan options having a reduced amount of air turbulence. Pilots may opt to divert to one of the different flight plan options as determined and presented by the air turbulence control unit 128.

Embodiments of the present disclosure provide the air turbulence analysis systems and methods that eliminate, minimize, or otherwise reduce the need for sporadic and infrequent reporting and the subjectivity of the reports. Aircraft 102 flying at different altitudes within the air space 104 may be grouped to generate turbulence service model layers to generate the turbulence model, which may be a three-dimensional model.

As used herein, the term “control unit,” “central processing unit,” “unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the air turbulence control unit 128 and the turbulence modeling control unit 130 may be or include one or more processors that are configured to control operation thereof, as described herein.

The air turbulence control unit 128 and the turbulence modeling control unit 130 are configured to execute a set of instructions that are stored in one or more data storage units or elements (such as one or more memories), in order to process data. For example, the air turbulence control unit 128 and the turbulence modeling control unit 130 may include or be coupled to one or more memories. The data storage units may also store data or other information as desired or needed. The data storage units may be in the form of an information source or a physical memory element within a processing machine.

The set of instructions may include various commands that instruct the air turbulence control unit 128 and the turbulence modeling control unit 130 as processing machines to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein may illustrate one or more control or processing units, such as the air turbulence control unit 128 and the turbulence modeling control unit 130. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the air turbulence control unit 128 and the turbulence modeling control unit 130 may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

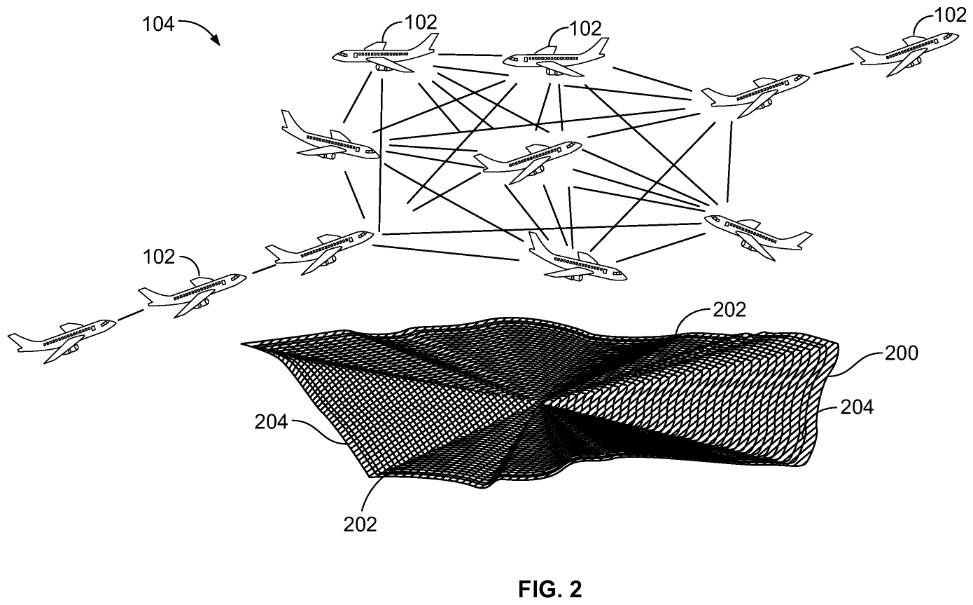

FIG. 2 illustrates a simplified view of a plurality of aircraft 102 within an air space 104 above a turbulence map 200, according to an embodiment of the present disclosure. Referring to FIGS. 1 and 2, the air turbulence control unit 128 receives the motion signals from all of the aircraft 102 within the air space 104 to provide an objective and accurate assessment of the locations of the air turbulence within the air space 104. The turbulence modeling control unit 130 generates the turbulence map 200 based on the locations of the air turbulence, as determined by the air turbulence control unit 128. As such, the aircraft 102 may avoid the areas of air turbulence, such as by flying above the air turbulence.

The turbulence map 200 may include three-dimensional contours 202 and shapes 204 (such as bounded regions) that indicate the locations and altitudes of air turbulence within the air space 104. The turbulence map 200 may indicate varying severities of air turbulence on the turbulence map 200, such as by different configurations and/or sizes of the shapes 204, color coding (for example, red may indicate locations of severe turbulence), and/or the like.

In at least one embodiment, the turbulence modeling control unit 130 stores air turbulence map over time, such as over 1 hour or more. The stored turbulence map data may be aggregated over time to form a dynamic turbulence map 200 (such as cine loop, video, or the like) that allows visualization of the locations of the turbulence in the air space 104 over time. Analysis of the locations of the turbulence over time may be used to predict future possible locations of air turbulence.

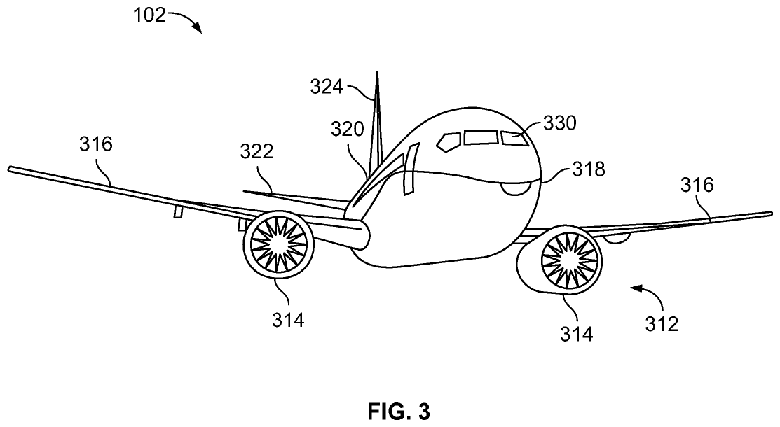

FIG. 3 illustrates a front perspective view of an aircraft 102, according to an exemplary embodiment of the present disclosure. The aircraft 102 includes a propulsion system 312 that may include two turbofan engines 314, for example. Optionally, the propulsion system 312 may include more engines 314 than shown. The engines 314 are carried by wings 316 of the aircraft 102. In other embodiments, the engines 314 may be carried by a fuselage 318 and/or an empennage 320. The empennage 320 may also support horizontal stabilizers 322 and a vertical stabilizer 324. The fuselage 318 of the aircraft 102 defines an internal cabin, which may include a cockpit 330, one or more work sections (for example, galleys, personnel carry-on baggage areas, and the like), one or more passenger sections (for example, first class, business class, and coach sections), and an aft section in which an aft rest area assembly may be positioned.

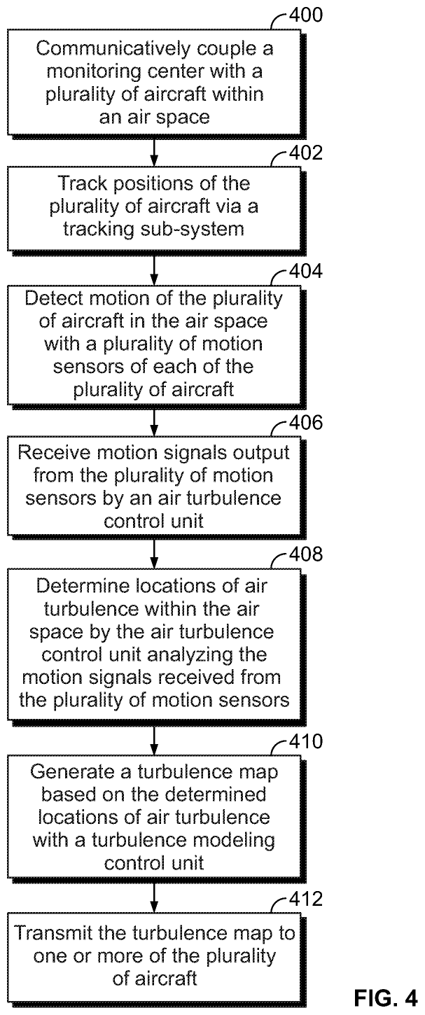

FIG. 4 illustrates a flow chart of an air turbulence analysis method, according to an embodiment of the present disclosure. Referring to FIGS. 1-4, the method steps or operations may begin at 400 by communicatively coupling the monitoring center 107 with the plurality of aircraft 102 within the air space 104. For example, the monitoring center 107 communicates with the aircraft 102 through the communication devices 110 of the aircraft and the communication device 124 of the monitoring center 107.

At 402, the positions of the plurality of aircraft 102 are tracked via the tracking sub-system 126. For example, the tracking sub-system 402 tracks the position signals output by the position sensors 112 of the aircraft 102. In at least one embodiment, the position signals may be ADS-B signals.

At 404, motion of each of the plurality of aircraft 102 in the air space 104 is detected with a plurality of motion sensors 106 of each of the plurality of aircraft 102. For example, each of the aircraft 102 may include ten or more motion sensors 106 that are configured to detect inertial motion of the aircraft 102.

At 406, the motion signals output by the motion sensors 106 are received by the air turbulence control unit 128. The air turbulence control unit 128 may directly receive the motion signals from each of the motion sensors 106, or the air turbulence control unit 128 may indirectly receive the motion signals from a motion data collection unit 108 of an aircraft 102 that collects and aggregates the motion signals. The motion signals from each aircraft 102 may be transmitted from each aircraft via the positon signals, for example, ADS-B signals. That is, the position signals may carry information related to both position of the aircraft 102 and detected motion of the aircraft 102 within the air space 104.

At 408, locations of air turbulence within the air space 104 are determined by the air turbulence control unit 128 based on the detected positions of the aircraft 102 and their associated motion signals. That is, the position signals received from the aircraft provide the current position (including geospatial location, altitude, heading, and/or the like) for each aircraft, and the motion signals provide motion data for the aircraft at the current position. The air turbulence control unit 128 correlates the current position and motion of the aircraft 102 to determine air turbulence at the current position of the aircraft 102.

At 410, a turbulence map based on the locations of air turbulence (as determined by the air turbulence control unit 128) is generated with the turbulence modeling control unit 130. At 412, the turbulence map is transmitted (for example, output) to one or more of the plurality of aircraft 102.

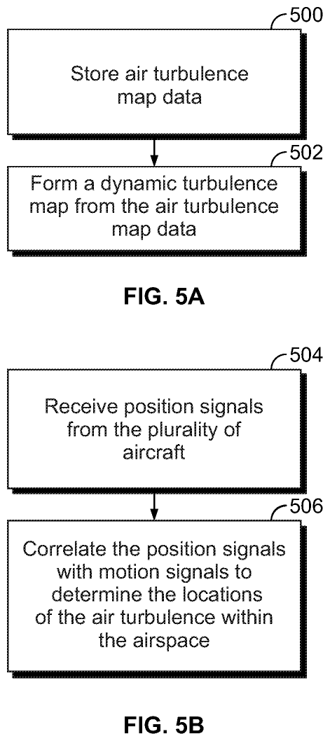

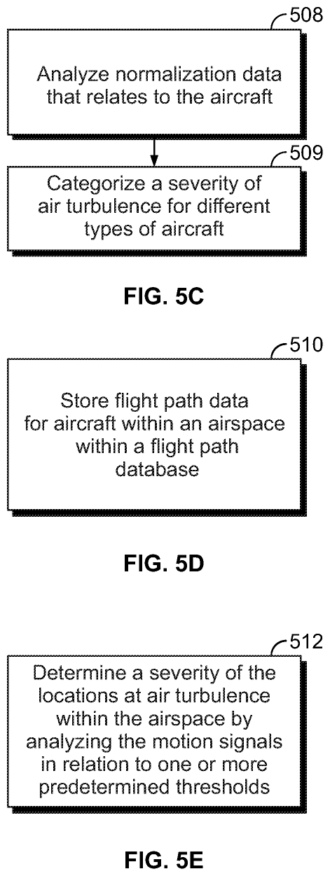

FIGS. 5A-5E illustrate flow charts of an air turbulence analysis method, according to an embodiment of the present disclosure. Referring to FIGS. 4 and 5A-5E, in at least one embodiment, the air turbulence analysis method (such as shown in FIG. 4) may also include storing air turbulence map data at 500 and forming a dynamic turbulence map from the air turbulence map data that is stored at 502.

In at least one embodiment, the air turbulence analysis method (such as shown in FIG. 4) may also include receiving at 504, by the air turbulence control unit 128, position signals from each of the plurality of aircraft 102. The position signals indicate the current positions of the plurality of the aircraft 102. within the air space 104. The method may also include correlating at 506, by the air turbulence control unit 128, the position signals with the motion signals to determine the locations of the air turbulence within the air space 104.

In at least one embodiment the air turbulence analysis method (such as shown in FIG. 4) may also include analyzing, at 508, normalization data that relates to the plurality of aircraft 102 to allow for an objective determination of air turbulence, and categorizing, at 509, a severity of air turbulence for different types of aircraft 102.

The air turbulence analysis method (such as shown in FIG. 4) may also include storing at 510 flight plan data for the plurality of aircraft 102 within the air space 104 within the flight plan database 132. The determining 408 may include comparing the motion signals with the flight plan data for the plurality of aircraft 102 to determine the locations of air turbulence within the air space 104. The determining 408 may also include determining a severity of the locations of air turbulence within the air space 104 by analyzing the motion signals in relation to one or more predetermined thresholds.

Referring to FIGS. 1-5, embodiments of the present disclosure provide systems and methods that allow large amounts of data to be quickly and efficiently analyzed by a computing device. For example, numerous aircraft 102 may be scheduled to fly within the air space 104. As such, large amounts of data are being tracked and analyzed. The vast amounts of data are efficiently organized and/or analyzed by the air turbulence control unit 128 and the turbulence modeling control unit 130, as described herein. The air turbulence control unit 128 and the turbulence modeling control unit 130 analyze the data in a relatively short time in order to quickly and efficiently output and/or display information regarding air turbulence locations within the air space 104. For example, the air turbulence control unit 128 and the turbulence modeling control unit 130 analyze current locations of the aircraft 102 and motion signals received therefrom in real or near real time. A human being would be incapable of efficiently analyzing such vast amounts of data in such a short time. As such, embodiments of the present disclosure provide increased and efficient functionality with respect to prior computing systems, and vastly superior performance in relation to a human being analyzing the vast amounts of data. In short, embodiments of the present disclosure provide systems and methods that analyze thousands, if not millions, of calculations and computations that a human being is incapable of efficiently, effectively and accurately managing.

As described herein, embodiments of the present disclosure provide systems and methods for accurately and timely determining locations of air turbulence within an air space. Embodiments of the present disclosure provide objective systems and methods of determining air turbulence within an air space.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

1. An air turbulence analysis system, comprising:
an air turbulence control unit that is configured to receive motion signals from one or more motion sensors of a plurality of aircraft within an air space, wherein the air turbulence control unit determines locations of air turbulence within the air space based on the motion signals.

2. The air turbulence analysis system of claim 1, further comprising a turbulence modeling control unit that is configured to generate a turbulence map based on the locations of air turbulence as determined by the air turbulence control unit.

3. The air turbulence analysis system of claim 2, wherein the turbulence modeling control unit is configured to transmit the turbulence map to one or more of the plurality of aircraft.

4. The air turbulence analysis system of claim 2, wherein the turbulence modeling control unit stores air turbulence map data, wherein the air turbulence map data is used to form a dynamic turbulence map that allows for visualization of locations of the turbulence in the air space over time.

5. The air turbulence analysis system of claim 1, wherein the air turbulence control unit is configured to receive position signals from each of the plurality of aircraft, wherein the position signals indicate the current positions of the plurality of the aircraft within the air space, and wherein the air turbulence control unit correlates the position signals with the motion signals to determine the locations of the air turbulence within the air space.

6. The air turbulence system of claim 5, wherein the motion signals are transmitted by the aircraft through the position signals.

7. The air turbulence system of claim 1, wherein the one or more motion sensors comprise a plurality of motions sensors, wherein each of the plurality of aircraft includes the plurality of motion sensors.

8. The air turbulence system of claim 1, wherein the one or more motion sensors comprise one or more an accelerometer, a gyroscope, an inertial sensor, or a global positioning system (GPS) unit.

9. The air turbulence system of claim 1, wherein the air turbulence control unit analyzes normalization data that relates to the plurality of aircraft, wherein the normalization data allows for an objective determination of air turbulence, and a severity of air turbulence to be categorized for different types of aircraft.

10. The air turbulence system of claim 1, wherein the air turbulence control unit is within a land-based monitoring center.

11. The air turbulence system of claim 1, further comprising at least one motion data collection unit that collects the motion signals.

12. The air turbulence system of claim 1, further comprising a flight plan database that stores flight plan data for the plurality of aircraft within the air space, wherein the air turbulence control unit compares the motion signals with the flight plan data for the plurality of aircraft to determine the locations of air turbulence within the air space.

13. The air turbulence system of claim 1, wherein the air turbulence control unit further determines a severity of the locations of air turbulence within the air space by analyzing the motion signals in relation to one or more predetermined thresholds.

14. An air turbulence analysis method, comprising:
receiving, by an air turbulence control unit, motion signals from one or more motion sensors of a plurality of aircraft within an air space; and
determining, by the air turbulence control unit, locations of air turbulence within the air space based on the motion signals.

15. The air turbulence analysis method of claim 14, further comprising
generating, by a turbulence modeling control unit, a turbulence map based on the locations of air turbulence as determined by the air turbulence control unit; and
transmitting the turbulence map to one or more of the plurality of aircraft.

16. The air turbulence analysis method of claim 15, further comprising:
storing air turbulence map data; and
forming a dynamic turbulence map from the air turbulence map data that is stored.

17. The air turbulence analysis method of claim 14, further comprising:
receiving, by the air turbulence control unit, position signals from each of the plurality of aircraft, wherein the position signals indicate the current positions of the plurality of the aircraft within the air space; and
correlating, by the air turbulence control unit, the position signals with the motion signals to determine the locations of the air turbulence within the air space.

18. The air turbulence method of claim 14, further comprising analyzing normalization data that relates to the plurality of aircraft to allow for an objective determination of air turbulence, and categorizing a severity of air turbulence to be categorized for different types of aircraft .

19. The air turbulence method of claim 14, further comprising:
storing flight plan data for the plurality of aircraft within the air space within a flight plan database, wherein the determining comprises comparing the motion signals with the flight plan data for the plurality of aircraft to determine the locations of air turbulence within the air space.

20. The air turbulence method of claim 14, wherein the determining further comprises determining a severity of the locations of air turbulence within the air space by analyzing the motion signals in relation to one or more predetermined thresholds.
